(19) United States
(12) Patent Application Publication
(10) Pub. No.: US 2012/0282814 A1
(43) Pub. Date: Nov. 8, 2012

(54) IN-LINE MULTIPORT PLUG AND SYSTEM

(76) Inventor: John G. Houdek, Sussex, WI (US)

(21) Appl. No.: 13/100,237

(22) Filed: May 3, 2011

(51) Int. Cl. H01R 25/00

(52) U.S. Cl. 439/650

(57) ABSTRACT

An in-line multiport plug comprises a block, a plug portion extending from the block and receptacle portion extending from the block. The block portion has a plurality of female AC connector sets, each female AC connector set having at least a hot electrical contact and a neutral electrical contact. The plug portion is configured to be received by a plug receptacle of an AC powered appliance and includes a female AC connector set. The receptacle portion is configured to receive the cord plug of an electrical cord having a female AC connector set. The receptacle portion includes a male AC connector set.

### BACKGROUND

Electrically powered appliances, such as computers, receive power through an electrical cord having a first end plugged into the electrically powered appliance and a second end plugged into an AC mains electrical outlet. Peripheral or auxiliary electrically powered devices, such as monitors, speakers, printers and the like, also typically require an AC mains electrical outlet for the supply of power. In many instances, there may be an insufficient number of AC mains electrical outlets at a location for all of the electrically powered appliances. Moreover, there may be insufficient space for multiport wands or surge protectors that plug into an AC mains electrical outlet, and power cords simply will not all conveniently reach designated AC outlet resulting in cords becoming entangled and twisted thus creating a “spaghetti like” mess, which is both unsightly and difficult to manage when attempting to connect, move or replace said peripheral or auxiliary devices.

### BRIEF DESCRIPTION OF THE DRAWINGS

FIG. 1 is a schematic illustration of a appliance powering system according to an example embodiment.

FIG. 2 is a schematic illustration of an in-line multiport plug of the system of FIG. 1 according to an example embodiment.

FIG. 3 is a schematic illustration of a first optional input feature of the plug of FIG. 2.

FIG. 4 is a schematic illustration of a second optional input feature of the plug of FIG. 2.

FIG. 5 is a schematic illustration of a third optional input feature of the plug of FIG. 2.

FIG. 6 is a schematic illustration of a fourth optional input feature of the plug of FIG. 2.

FIG. 7 is a schematic illustration of an optional output feature of the plug of FIG. 2.

FIG. 8 is a first perspective view of an embodiment of the plug of FIG. 2 according to an example embodiment.

FIG. 9 is a second perspective view of the plug of FIG. 8 according to an example embodiment.

FIG. 10 is a third perspective view of the plug of FIG. 8 according to an example embodiment.

FIG. 11 is a fourth perspective view of the plug of FIG. 8 according to an example embodiment.

FIG. 12 is the first perspective view of the plug of FIG. 8 with portions shown in phantom or in a transparent state.

FIG. 13 is a first perspective view of a second embodiment of the plug of FIG. 2 according to an example embodiment.

FIG. 14 is a second perspective view of the plug of FIG. 13 according to an example embodiment.

FIG. 15 is a third perspective view of the plug of FIG. 13 according to an example embodiment.

FIG. 16 is a first perspective view of a third embodiment of the plug of FIG. 2 according to an example embodiment.

FIG. 17 is a second perspective view of the plug of FIG. 16 according to an example embodiment.

FIG. 18 is a third perspective view of the plug of FIG. 16 according to an example embodiment.

FIG. 19 is a first perspective view of a third embodiment of the plug of FIG. 2 according to an example embodiment.

FIG. 20 is a second perspective view of the plug of FIG. 19 according to an example embodiment.

FIG. 21 is a third perspective view of the plug of FIG. 19 according to an example embodiment.

FIG. 22 is a top plan view of a fourth embodiment of the plug of FIG. 2 according to an example embodiment.

FIG. 23 is a side elevational view of the fourth embodiment of the plug of FIG. 22 according to an example embodiment.

FIG. 24 is a side elevational view of the fourth embodiment of the plug of FIG. 22 according to an example embodiment.

### DETAILED DESCRIPTION OF THE EXAMPLE EMBODIMENTS

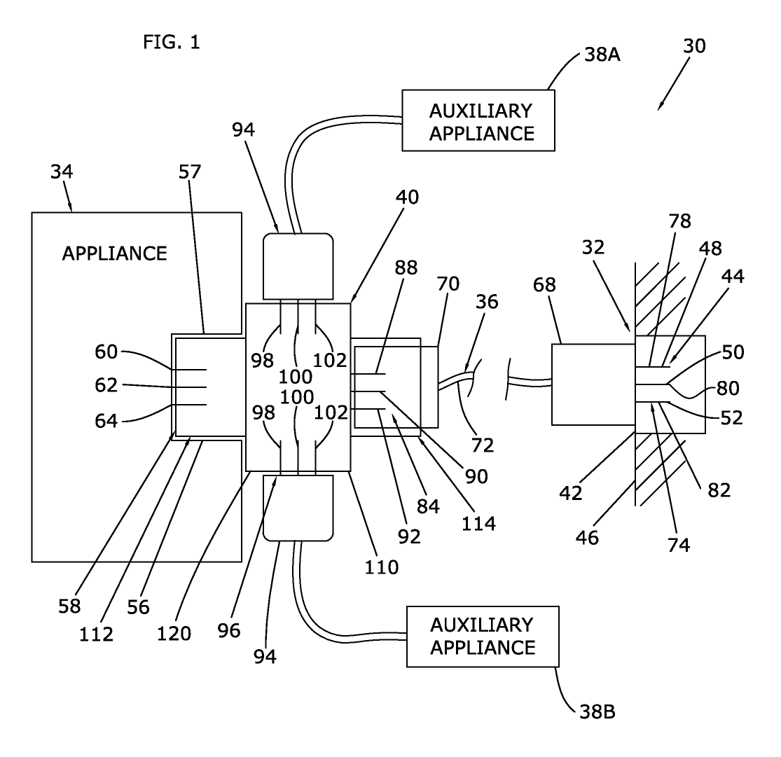

FIG. 1 schematically illustrates an appliance powering system 30 according to one example embodiment. As will be described hereafter, appliance powering system 30 allows multiple AC powered appliances to be powered with electrical outlets and with less space. Appliance powering system 30 comprises AC mains 32, AC powered appliance 34, electrical cord 36, auxiliary appliances 38A, 38B (collectively referred to as auxiliary appliances 38) and in-line multiport plug 40.

AC mains 32 comprises a source of alternating current electrical power. AC mains 32 includes an electrical outlet 42 having a female electrical connector set 44. In the example illustrated, electrical outlet 42 is provided along a surface of a wall 46. Female electrical connector set 44 includes a hot electrical contact 48, a neutral electric contact 50 and a grounded electrical contact 52. In other embodiments, female connector set 44 may omit the grounded electrical contact 52. In one embodiment, AC mains 32 comprises a source of 125 V, 10 to 15 amp alternating current electrical power. In other embodiments, electrical outlet 42 may be provided at other locations may have other electrical power characteristics.

Alternating current powered appliance 34 comprises an electrical appliance configured to be powered by the electrical power provided by electric outlet 42. In one embodiment, appliance 34 is powered by unmodified electrical power from AC mains 32. In another embodiment, appliance 34 is powered by modified electrical power from AC mains 32. Appliance 34 includes plug receptacle 56 and a male AC connector set 58. Plug receptacle 56 comprises a cavity or avoid 57 configured to receive a plug having a female connector set, such as provided by cord 36. In the example illustrated, male AC connector set 58 includes a hot electrical contact 60, a neutral electrical contact 62 and a ground electrical contact 64. Such electrical contacts 60, 62 and 64 comprise prongs or pins. In some embodiments, neutral electrical contact may be omitted. Examples of alternating current power appliance 34 include, but are not limited to, computers, home theater systems, medical patient monitors, televisions, network routers and switches and the like.

Cord 36 comprises an electrical cord configured to electrically connect appliance 34 to AC mains 32. Cord 36 includes cord plugs 68, 70 and intermediate electrical line 72. Cord plug 68 is located at a first end of electrical line 72 and includes a male AC connector set 74 including a hot electrical contact 78, a neutral electrical contact 80 and a grounded electrical contact 82. In one embodiment, such contacts of connector set 74 comprise electrically conductive prongs or pins. As shown by FIG. 1, cord plug 68 is plugged into electrical outlet 42 to provide electrical connection between contacts 48, 50 and 52 with contact 78, 80 and 82, respectively.

Cord plug 70 is located at a second opposite end of electrical line 72 and is configured to be received within an mate within an interior of cavity 57. In the embodiment, cord plug 70 has a body with an outer peripheral shape or profile matching an inner peripheral shape or profile of cavity 56. In the example illustrated, cord plug 70 includes a female connector set 84 including a hot electrical contact 88, a neutral electrical contact 90 and a grounded electrical contact 92. In some embodiments, the grounded electric contact 92 may be omitted.

Electrical line 72 comprises a flexible line of electrical wiring extending between plugs 68 and 70. In embodiments where plugs 68 and 70 each include hot, neutral and grounded electrical contacts, line 72 includes three corresponding electrically separated or isolated wires or lines interconnecting the hot electrical contacts, the neutral electrical contact in the grounded electrical contacts of the plugs. In embodiments where plugs 68 and 70 omit the grounded electrical contacts, line 72 includes two electrical wires connecting the hot and neutral contacts.

Auxiliary appliances 38 comprise appliances that are to be used at locations in close proximity to appliance 34. Auxiliary appliances 38 comprise peripheral devices which are electrically powered from AC mains 32 through cord 36 and through plug 40. Each of auxiliary appliances 38 includes a plug 94 having a male electrical connector set 96 including a hot electrical contact 98, a neutral electrical contact 100 and grounded electrical contact 102. In the example illustrated, such contacts comprise electrically conductive prongs or pins. In some embodiments, the grounded electrical contacts 102 may be omitted. As shown by FIG. 1, male electrical connector set 96 is plugged into plug 40.

Plug 40 splits or transmits electric power to a plurality of recipients, auxiliary appliances 38. Plug 40 is in line between appliance 34 and AC mains 32 so as to allow a single AC mains 32 to power multiple appliances while also reducing floor or shelf space demands. Plug 40 comprises block 110, plug portion 112 and receptacle portion 114.

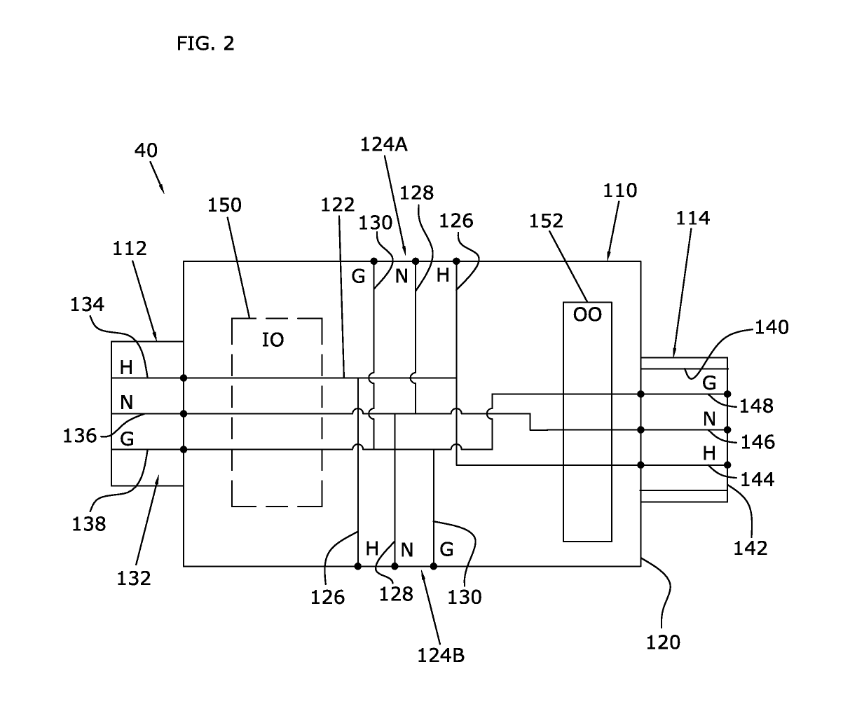

FIG. 2 schematically illustrates plug 40 in more detail. As shown by FIG. 2, block 110 comprises body 120, electrically conductive lines 122 and female AC connector sets 124A and 124B (collectively referred to as connector sets 124). Body 120 comprises a structure, outer mass, shell or enclosure encapsulating, surrounding, supporting and enclosing electrically conductive lines 122 and connector sets 124. Electrically conductive lines 122 electrically connect connector sets 124. Female AC connector sets 124 are configured to mate with corresponding mail AC connector sets 96 of auxiliary appliances 38. In one embodiment, connector sets 124 may be the same. In other embodiments, connector sets 124 may be different for electrically connecting to different plugs 94. In the example illustrated, each connector set 124 includes a hot electrical contact 126, a neutral electrical contact 128 and a grounded electrical contact 130. In the example illustrated, each electrical contact 128, 130, 132 is contained within an externally accessible opening or slot within body 120 such that insertion of a male electrical connector set into the opening slot causes electrical connection between the female electrical connector set and the male electrical connector set. In some embodiments, the grounded electrical contacts 130 may be omitted.

Plug portion 112 comprises a member outwardly projecting from block 110 having an outer peripheral profile matching that of the inner peripheral profile of cavity 57 of appliance 34 (shown in FIG. 1). Plug portion 112 also has an outer peripheral profile substantially identical to the outer peripheral profile of plug 70 of cord 36. Plug portion 112 includes a female connector set 132 configured to be electrically connected to male electrical connector set 58 of appliance 34. Female connector set 132 includes a hot electrical contact 134, a neutral electrical contact 136 and a grounded electrical contact 138. Each electrical contact number 134, 136, 138 is contained within an externally accessible opening or slot within an exterior body of plug portion 112 such that insertion of a male electrical connector set 58 into the opening or slot causes electrical connection between the female electrical connector set 132 and the male electrical connector set 58. In some embodiments, the grounded electrical contacts 138 may be omitted. Because plug portion 112 has an outer peripheral profile substantially matching the inner peripheral profile of cavity 57, plug 40 may be plugged into cavity 57 such that plug 50 is suspended or cantilevered by its interaction with cavity 57 along a side of appliance 34. As a result, plug 40 does not occupy valuable floor or shelf space and electrical connections to plug 40 are elevated to reduce cable tangling and clutter.

Receptacle portion 114 comprises a member outwardly projecting from block 110 so as to provide a two sided wall forming a cavity 140 having an inner peripheral profile matching that of the outer peripheral profile of plug 70 of cord 36 (shown in FIG. 1). Receptacle portion 114 also has an inner peripheral profile substantially identical to the inner peripheral profile of cavity 57 of appliance 34. Receptacle portion 114 includes a male connector set 142 configured to be electrically connected to female electrical connector set 84 of plug 70 of cord 36. Male connector set 142 includes a hot electrical contact 144, a neutral electrical contact 146 and a grounded electrical contact 148. Each electrical contact 144, 146, 148 a prong or pin projecting into cavity 140 of receptacle portion 114 such that insertion of a male electrical connector set 142 into the openings or slots a female connector set 84 of plug 70 causes electrical connection between the female electrical connector set 84 and the male electrical connector set 142. In some embodiments, the grounded electrical contacts 148 may be omitted. Because receptacle portion 114 has an inner peripheral profile substantially matching the outer peripheral profile of plug 70, plug 40 effectively replaces a single cavity 57 of appliance 34 with the same cavity 140 while the same time providing additional female connector sets 124.

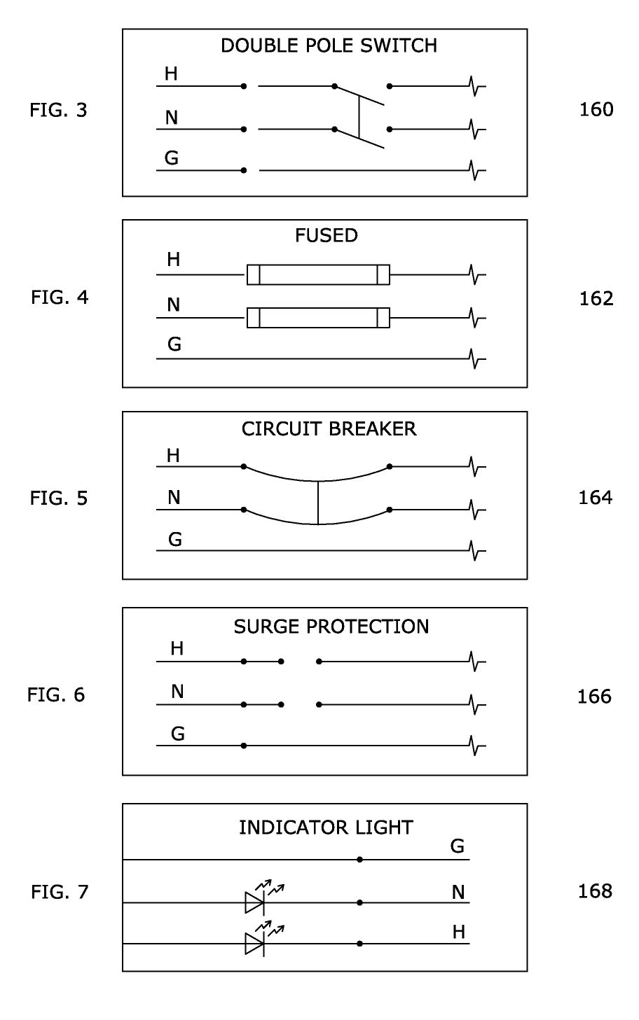

As further shown by FIG. 2, in some embodiments, plug 40 may include additional optional input features 150 and optional output features 152. Features 151 and 152 are supported or carried by block 110. FIG. 3-6 illustrate examples of input features 160, 162, 164 and 166, one or more of which may be provided in a single block 110 of plug 40. As shown by FIG. 3, input feature 160 comprises an on-off switch, allowing the supply of power to be cut off to appliance 34 or appliance 34 and auxiliary appliances 38, depending upon where in the circuit the double poll switch is implemented.

As shown by FIG. 4, input feature 162 comprises fuses on both the hot and neutral electrical lines. In other embodiments, input feature 162 may include a fuse on one of the electrical lines. Input feature 162 prevents voltage surges above a predefined amount which might damage appliance 34 and/or auxiliary appliances 38. As shown by FIG. 5, input feature 164 comprises a circuit breaker. As shown by FIG. 6, input feature 166 comprises a surge protection mechanism or device. Each of the input features 160, 162, 164 and 166 may be used alone or in combination with one another as part of block 110 of plug 40.

FIG. 7 illustrates an optional output feature 168 which may be provided as part of an carried by block 110. As shown by FIG. 7, output feature 168 is configured to provide an indication of when powers being supplied through block 40. In the example illustrated, indication is provided by lights or light emitting diodes on one or both of the hot and neutral electrical lines within block 110. In other embodiments, other indications may be provided. In yet some embodiments, features 160, 162, 64, 166 168 may be omitted.

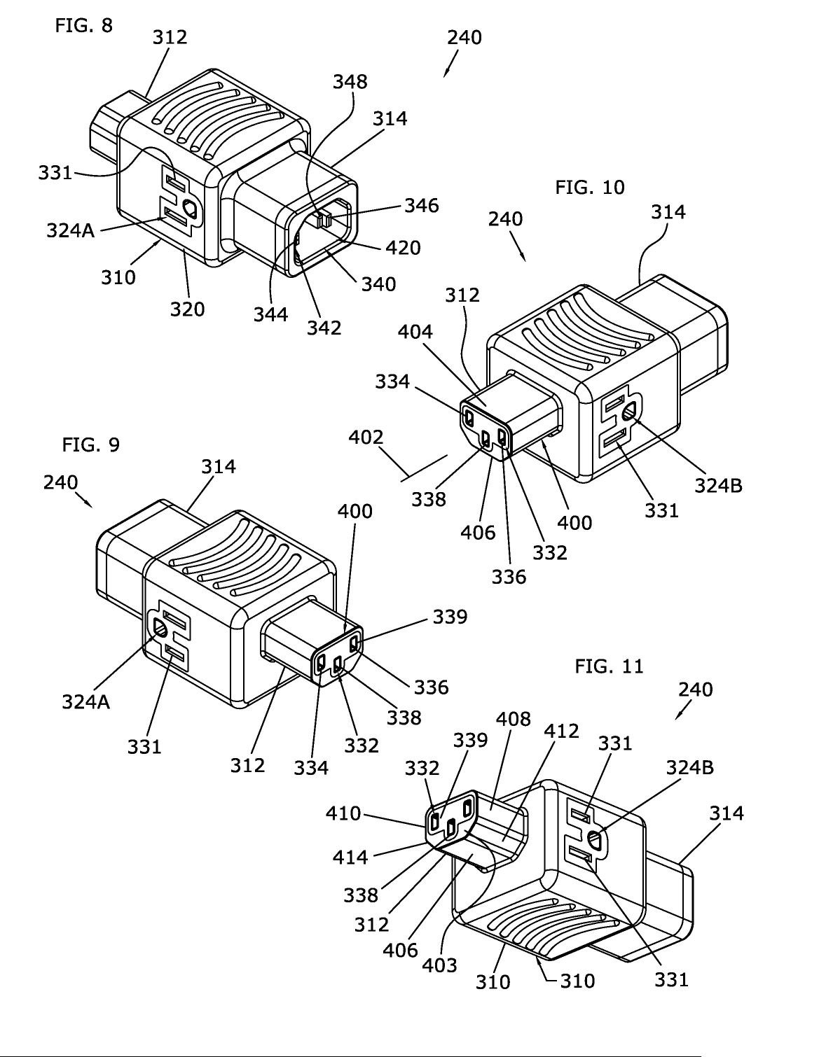

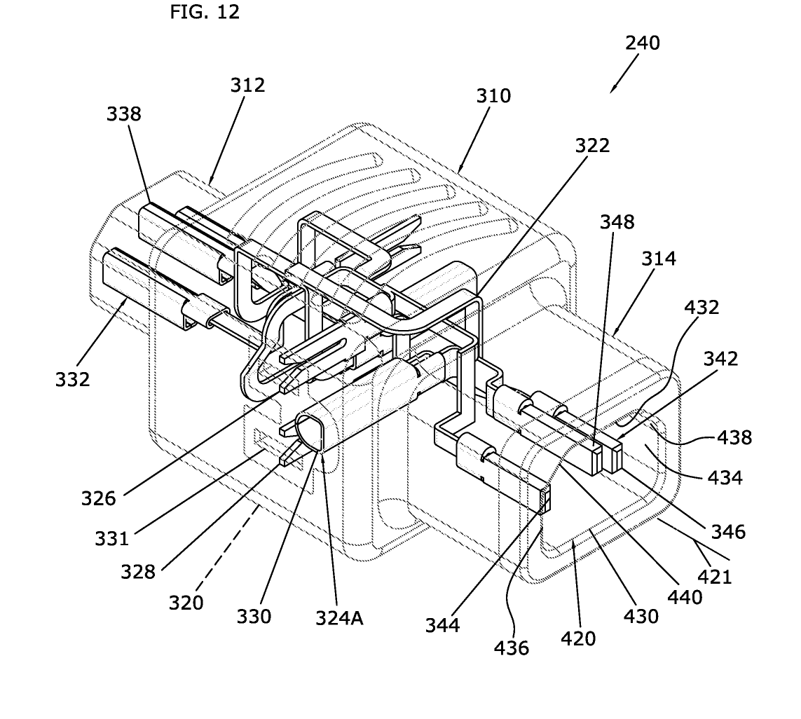

FIGS. 8-12 are perspective views illustrating in-line multiport plug 240, a particular embodiment of plug 40. FIG. 12 is a perspective view of the plug 240 shown in FIG. 8 except that the body of plug 240 is shown in phantom to illustrate electrical conductor lines 322. As shown by FIGS. 8-11, plug 240 includes block 310, plug portion 312 and receptacle portion 314. Block 310 comprises body 320, electrically conductive lines 322 (shown in FIG. 12) and female AC connector sets 324A and 324B (collectively referred to as connector sets 324). Body 320 comprises a structure, outer mass, shell or enclosure encapsulating, surrounding, supporting and enclosing electrically conductive lines 122 and connector sets 324. Electrically conductive lines 322 electrically connect connector sets 324. Female AC connector sets 324 are configured to mate with corresponding mail AC connector sets 96 of auxiliary appliances 38 (shown in FIG. 1).

In one embodiment, connector sets 324 may be the same. In other embodiments, connector sets 324 may be different for electrically connecting to differently configured plugs 94 (schematically shown in FIG. 1). In the example illustrated, each connector set 324 includes a hot electrical contact 326, a neutral electrical contact 328 and a grounded electrical contact 330. In the example illustrated, each electrical contact 328, 330, 332 is contained within an externally accessible opening or slot 331 within body 320 such that insertion of a male electrical connector set into the opening slot causes electrical connection between the female electrical connector set and the male electrical connector set. In some embodiments, the grounded electrical contacts 330 may be omitted. Although not shown for ease of illustration, in some embodiments, block 310 of plug 240 may include one or more of the features 160, 162, 164, 166 and 168 shown and described above with respect to FIGS. 3-7.

Plug portion 312 comprises a member outwardly projecting from block 310 having an outer peripheral profile matching that of the inner peripheral profile of cavity 57 of appliance 34 (shown in FIG. 1). Plug portion 312 also has an outer peripheral profile substantially identical to the outer peripheral profile of plug 70 of cord 36. In the example illustrated, the plug portion 312 has a peripheral profile 400 about a first axis 402 and extending from an axially facing surface 403. The peripheral profile 402 consists of (excluding any rounded intermediate edges) six side surfaces along the first axis 402. The six side surfaces include a first side surface 404 on a first side of the first axis 402 having a first width perpendicular to the first axis 402, a second side surface 406 on a second side of the first axis opposite the first side, the second side surface having a second width perpendicular to the first axis 402 less than the first width, a third side surface 408 on a third side of the first axis and extending from the first side surface 404 perpendicular to the first side surface, a fourth side surface 410 on a first side of the first axis 402 and extending from the first side surface perpendicular first side surface 404, a fifth side surface 412 along the first axis 402 and obliquely extending from the third side surface 408 to the second side surface 406, and a sixth side surface 414 along the first axis 402 and obliquely extending from the fourth side surface 410 to the second side surface 406. In other embodiments, profile 402 may have other configurations.

Plug portion 312 includes a female connector set 332 configured to be electrically connected to male electrical connector set 58 of appliance 34. Female connector set 332 includes a hot electrical contact 334, a neutral electrical contact 336 and a grounded electrical contact 338. Each electrical contact 334, 336, 338 is contained within an externally accessible opening or slot 339 within an exterior body of plug portion 312 and recessed into surface 403 such that insertion of a male electrical connector set 58 into the opening or slot causes electrical connection between the female electrical connector set 332 and the male electrical connector set 58. In some embodiments, the grounded electrical contacts 338 may be omitted. Because plug portion 312 has an outer peripheral profile substantially matching the inner peripheral profile of cavity 57, plug 240 may be plugged into cavity 57 such that plug 240 is suspended or cantilevered by its interaction with cavity 57 along a side of appliance 34 (shown in FIG. 1). As a result, plug 240 does not occupy valuable floor or shelf space and electrical connections to plug 240 are elevated to reduce cable tangling and clutter.

Receptacle portion 314 comprises a member outwardly projecting from block 310 forming a cavity 340 having an inner peripheral profile 420 matching that of the outer peripheral profile of plug 70 of cord 36 (shown in FIG. 1). Receptacle portion 314 also has an inner peripheral profile 420 substantially identical to the inner peripheral profile of cavity 57 of appliance 34. As shown by FIG. 12, in the example embodiment illustrated, the inner peripheral profile 420 consists of six inwardly facing inner side surfaces along a second axis 421. In one embodiment, axes 402 and 421 may be coincident. In another embodiment, axes 402 and 421 may be offset from one another. The six inwardly facing inner side surfaces consist of (excluding the rounded intermediate edges) a first inner side surface 430 on a first side of the cavity having a first width perpendicular to the second axis 421, a second inner side surface 432 on a second side of the cavity, the second inner side surface having a second width perpendicular to the second axis 421 less than the first width, a third inner side surface 434 on a third side of the first axis and extending from the first inner side surface 430 perpendicular to the first inner side surface 430, a fourth inner side surface 436 on a first side of the second axis 421 and extending from the first inner side surface 430 perpendicular first inner side surface 430, a fifth inner side surface 438 along the second axis 421 and obliquely extending from the third inner side surface 434 to the second inner side surface 432, and a sixth inner side surface 440 along the second axis 421 and obliquely extending from the fourth inner side surface 436 to the second inner side surface 432. In other embodiments, profile 420 may have other configurations.

Receptacle portion 314 includes a male connector set 342 configured to be electrically connected to female electrical connector set 84 of plug 70 of cord 36. Male connector set 342 includes a hot electrical contact 344, a neutral electrical contact 346 and a grounded electrical contact 348. Each electrical contact 344, 346, 348 comprises a prong or pin projecting into cavity 340 of receptacle portion 314 such that insertion of a male electrical connector set 342 into the openings or slots a female connector set 84 of plug 70 causes electrical connection between the female electrical connector set 84 and the male electrical connector set 342. In some embodiments, the grounded electrical contact 348 may be omitted. Because receptacle portion 314 has an inner peripheral profile substantially matching the outer peripheral profile of plug 70, plug 240 effectively replaces a single cavity 57 of appliance 34 with the same cavity 340 while the same time providing additional female connector sets 324.

In the example illustrated, the exterior body of block 310, the exterior body of plug portion 312 and the exterior body of receptacle portion 314 are formed from one or more polymeric electrically insulating materials. In the example illustrated, the exterior bodies are integrally formed as a single unitary body with one another about the electrical contacts and electrical lines. In other embodiments, the exterior body maybe formed separately and welded, fused, bonded, snapped or otherwise joined to one another.

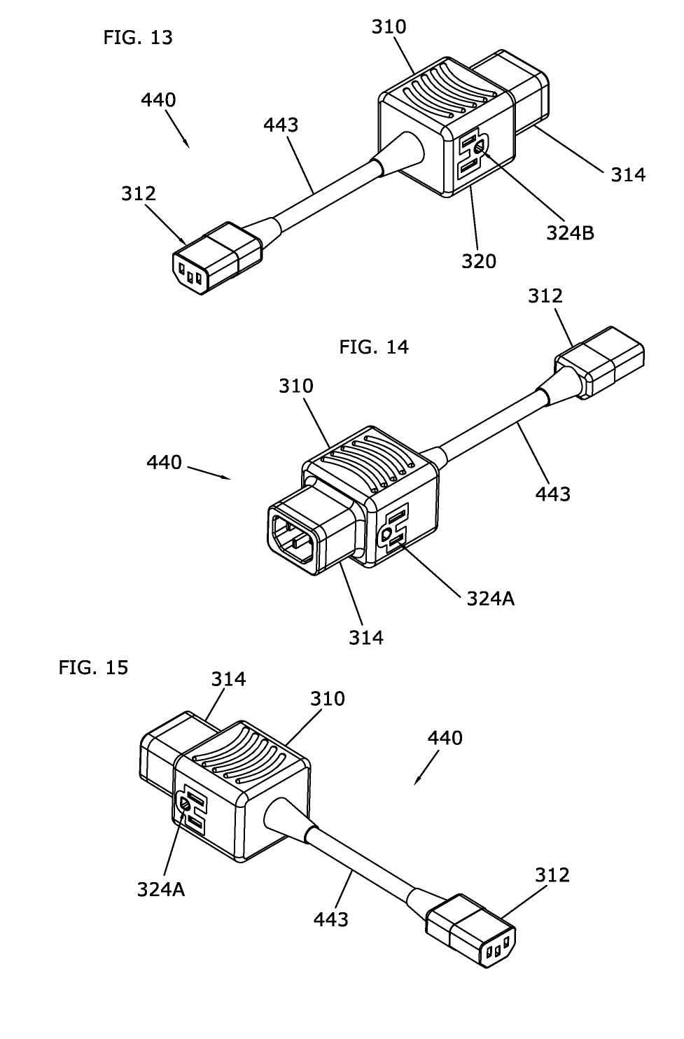

FIGS. 13-15 are perspective views illustrating plug 440, another embodiment of plug 240 shown in FIGS. 8-12. Plug 440 is substantially identical to plug 240 except that plug 440 additionally includes a flexible cable portion 443. Those remaining portions of plug 440 which correspond to similar components of plug 240 are numbered similarly.

Cable portion 443 extends between block 310 and plug portion 312. Cable portion 443 comprises electrical lines surrounded by an electrically insulating sheath or outer covering. In the example illustrated, the electrical lines include a hot electrical line, a neutral electrical line in a ground electrical line connecting 322 and the hot, neutral and grounded electrode contacts, respectively, of the female connector set 332. In embodiments where female connector set 33 to omit a grounded electrical contact, the ground electrical line of cable portion 443 may be omitted. Cable portion 443 flexibly connects plug portion 312 to block 310, allowing block 310 and its auxiliary electrical ports to project or be suspended further away from a wall or backside of electrical line 34, (shown in FIG. 1), to provide easier access and easier connection to plug 440 while still conserving valuable surrounding floor or shelf space.

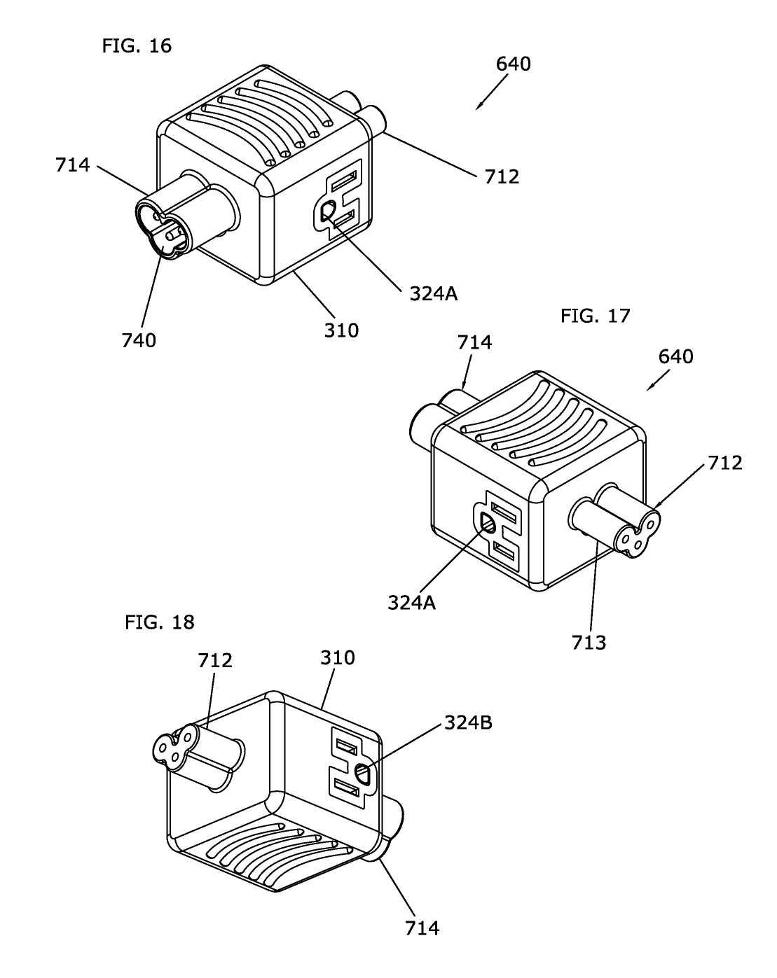

FIGS. 16-18 are perspective views illustrating in line multiport plug 640, another embodiment of plug 240. Plug 640 is substantially identical to plug 240 except that instead of having a plug portion comprising a C13 type IEC connector and receptacle portion comprising a C14 type IEC connector, plug 640 has a plug portion 712 comprising a C5 type IEC connector and a receptacle portion 714 comprising a C6 type IEC connector cavity or inlet. Those remaining elements or components of plug 640 which correspond to components of plug 240 are numbered similarly. As shown by FIGS. 16-18, plug portion 712 comprises a plurality of interconnected cylindrical portions 713 similar to a cloverleaf or “Mickey Mouse” silhouette. Receptacle portion 714 has an inner cavity 740 with a similar inner profile.

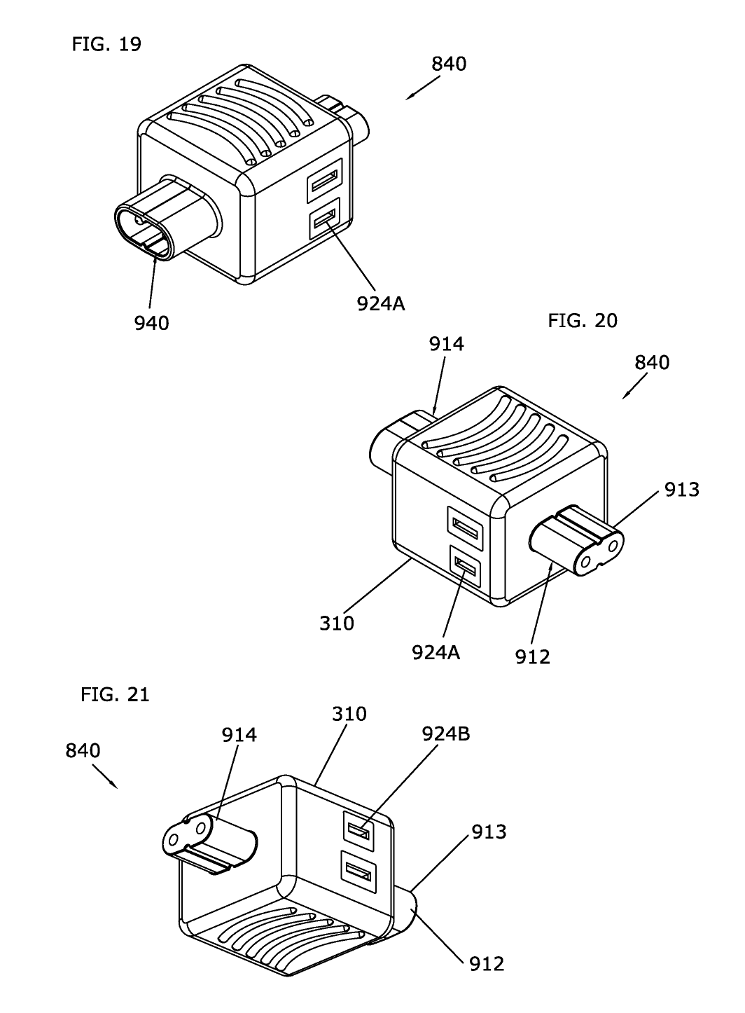

FIGS. 19-21 are perspective views illustrating an in-line multiport plug 840, another embodiment of plug 240. Plug 840 is similar to plug 640 except that plug 840 has a plug portion 912 comprising a C7 type IEC connector and a receptacle portion 914 comprising a C8 type IEC connector cavity or inlet. Plug 840 also includes female connector sets 924A and 924B in place of connector sets 324A and 324B. Those remaining elements or components of plug 840 which correspond to components of plug 240 are numbered similarly. As shown by FIGS. 19-21, plug portion 912 comprises a plurality of interconnected cylindrical portions 913 similar to a FIG. 8 or shotgun silhouette (also known as a “euroconnector”). Receptacle portion 914 has an inner cavity 940 with a similar inner profile. Connector sets 924 are similar to connector sets 324 except that connector sets 924 omit a grounded electrical contact.

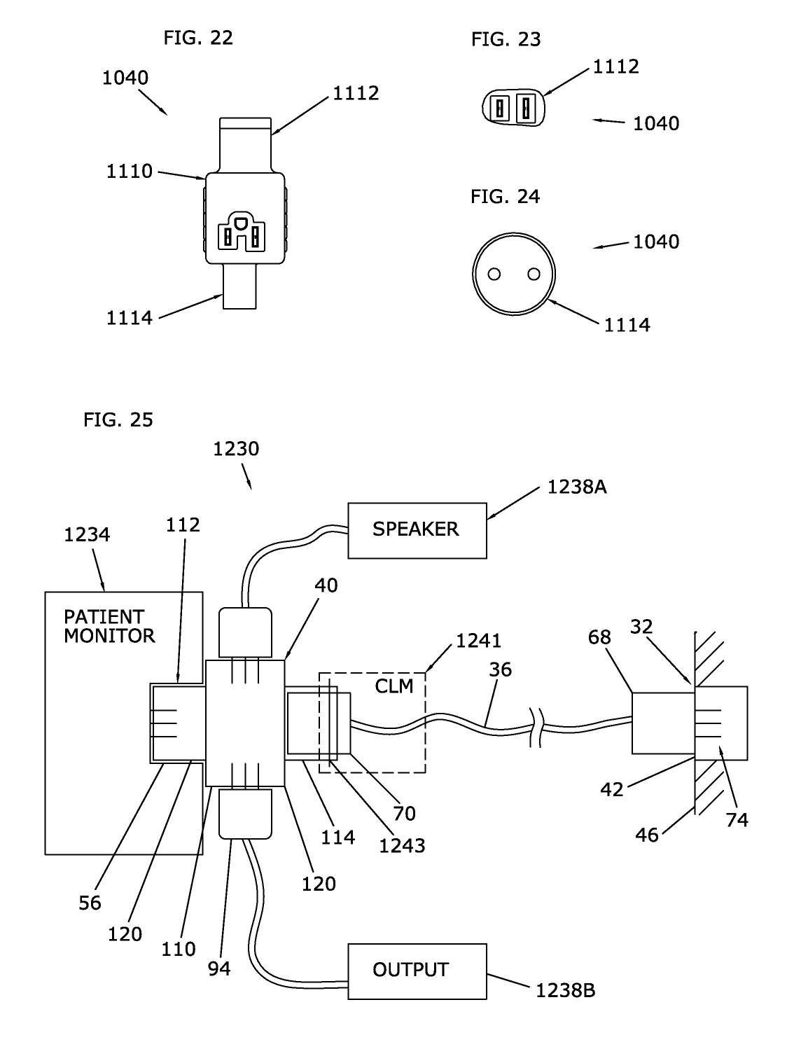

FIGS. 22-24 are elevational views illustrating an in-line multiport plug 1040, embodiment of plug 240. Plug 1040 is similar to plug 240 except that plug 840 has a plug portion 1112 comprising a European style connector and a receptacle portion 914 comprising a European style connector cavity or inlet. Those remaining elements or components of plug 1040 which correspond to components of plug 240 are numbered similarly.

FIG. 25 schematically illustrates appliance powering system 1230 according to one example embodiment. Appliance powering system 1230 is similar to appliance powering system 30 except that with powering system 1230, the AC powered appliance comprises a patient monitor 1234, that the auxiliary appliance comprises an alarm speaker 1238A and that the other auxiliary appliance comprises an output 1238B. Those remaining components of system which correspond to elements of system 30 are numbered similarly.

In the appliance powering system 1230, in-line multiport plug 40 offers several unique benefits. Plug 40 provides a double fault condition for audio alarms such as provided by speaker 1238A. Should power to speaker 1238A become disrupted, the supply of power to patient monitor 1234 will also become disrupted. In other words, the loss of AC power to speaker 1238A loss result in loss of power to the host monitor patient monitor 1234, a condition that would be immediately known and resolved by a caregiver. Plug 40 provide such a double fault condition without requiring use of a speaker 1238A configured to be directly powered from patient monitor 1234. In the example illustrated, system 1230 additionally includes an optional cable locking mechanism 1241 (schematically shown in broken lines). Cable locking mechanism 1241 is configured to retain plug 70 of cord 36 within receptacle portion 114 of plug 40. In one embodiment, block 110 or receptacle portion 114 of plug 40 includes one or more detents 1243 configured to receive one or more projections of cable locking mechanism 1241. In other embodiments, this relationship may be reversed. In still other embodiments, cable locking mechanism 1241 the other configurations or may be omitted.

Although the present disclosure has been described with reference to example embodiments, workers skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

What is claimed is:

1. An apparatus comprising:
an in-line multiport plug comprising:
a block having a plurality of female AC connector sets, each female AC connector set having at least a hot electrical contact and a neutral electrical contact;
a plug portion extending from the block in a first direction along a first axis and configured to be received by a plug receptacle of an AC powered appliance, the plug portion comprising a female AC connector set; and
a receptacle portion extending from the block along a second axis and configured to receive the cord plug of an electrical cord having a female AC connector set, the receptacle portion having a male AC connector set.

2. The apparatus of claim 1, wherein the plug portion has a peripheral profile about the first axis, the peripheral profile consisting of six side surfaces along the first axis, the six side surfaces including a first side surface on a first side of the first axis having a first width perpendicular to the first axis, a second side surface on a second side of the first axis opposite the first side, the second side surface having a second width perpendicular to the first axis less than the first width, a third side surface on a third side of the first axis and extending from the first side surface perpendicular to the first side surface, a fourth side surface on a first side of the first axis and extending from the first side surface perpendicular first side surface, a fifth side surface along the first axis and obliquely extending from the third side surface to the second side surface, and a sixth side surface along the first axis and obliquely extending from the fourth side surface to the second side surface.

3. The apparatus of claim 2, wherein the receptacle portion has a cavity with an inner peripheral profile consisting of six inwardly facing inner side surfaces along the second axis, the six inwardly facing inner side surfaces including a first inner side surface on a first side of the cavity having a first width perpendicular to the second axis, a second inner side surface on a second side of the cavity, the second inner side surface having a second width perpendicular to the second axis less than the first width, a third inner side surface on a third side of the first axis and extending from the first inner side surface perpendicular to the first inner side surface, a fourth inner side surface on a first side of the second axis and extending from the first inner side surface perpendicular first inner side surface, a fifth inner side surface along the second axis and obliquely extending from the third inner side surface to the second inner side surface, and a sixth inner side surface along the second axis and obliquely extending from the fourth inner side surface to the second inner side surface.

4. The apparatus of claim 1, the receptacle portion has a cavity with an inner peripheral profile consisting of six inwardly facing inner side surfaces along the second axis, the six inwardly facing inner side surfaces including a first inner side surface on a first side of the cavity having a first width perpendicular to the second axis, a second inner side surface on a second side of the cavity, the second inner side surface having a second width perpendicular to the second axis less than the first width, a third inner side surface on a third side of the first axis and extending from the first inner side surface perpendicular to the first inner side surface, a fourth inner side surface on a first side of the second axis and extending from the first inner side surface perpendicular first inner side surface, a fifth inner side surface along the second axis and obliquely extending from the third inner side surface to the second inner side surface, and a sixth inner side surface along the second axis and obliquely extending from the fourth inner side surface to the second inner side surface.

5. The apparatus of claim 1, wherein the plug portion comprises a plurality of interconnected cylindrical portions, each political portion including an electrical contact.

6. The apparatus of claim 1, wherein each of the plurality of female connector sets comprises:
a first female connector set facing in a second direction perpendicular to the first direction; and
the second female connector set facing in a third direction perpendicular to the first direction and away from the second direction.

7. The apparatus of claim 1, wherein each of the plurality of female connector sets further comprises a ground electrical contact.

8. The apparatus of claim 1 further comprising a flexible cord between the block and the plug portion.

9. The apparatus of claim 1 further comprising a first fuse carried by the body and electrically connected to one of the hot electrical contact and the neutral electrical contact.

10. The apparatus of claim 1 further comprising a voltage presence indication carried by the body.

11. The apparatus of claim 1 further comprising a double pole switch carried by the body and electrically connected to the hot electrical contact in the neutral electrical contact.

12. The apparatus of claim 1 further comprising a circuit breaker carried by the body.

13. The apparatus of claim 1 further comprising surge protection carried by the body.

14. The apparatus of claim 1, wherein the block comprises electrical conductors and a body about the electrical conductors and wherein the body is transparent.

15. The apparatus of claim 1, wherein the plurality of female connector sets comprise a plurality of NEMA 5-15 compatible outlets.

16. The apparatus of claim 1 further comprising:
the powered appliance having the plug receptacle; and
the electrical cord, wherein a first end of electrical cord has the cord plug which is received within the receptacle portion and wherein a second end of electrical cord is plugged into an AC mains.

17. The apparatus of claim 16, wherein the power of life comprises a patient monitor and wherein the apparatus further comprises an AC powered speaker electrically connected to and receiving power through one of the plurality of female connector sets.

18. The apparatus of claim 1, wherein portions of the block, the plug portion and the receptacle portion are, together, integrally formed as a single unitary body.

19. The apparatus of claim 18 further comprising a cable locking mechanism coupled to the electrical cord and at least one of the block and the receptacle portion, the cable locking mechanism being configured to inhibit separation of the cord from said one of the block and the receptacle portion.

20. The apparatus of claim 1, when the plug portion and the receptacle portion are spaced from one another by less than or equal to 2 inches.
